(19) United States
(12) Patent Application Publication
(10) Pub. No.: US 2006/0112728 A1
(43) Pub. Date: Jun. 1, 2006

(54) Producing method of drawn glass member, producing method for spacer for image display apparatus and producing method for image display apparatus

(75) Inventor: Nobuyuki Nakagawa, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/283,863

(22) Filed: Nov. 22, 2005

(30) Foreign Application Priority Data
Nov. 29, 2004 (JP) 2004-343565

(51) Int. Cl. C03B 23/047

(52) U.S. Cl. 65/104; 65/434

(57) ABSTRACT

A producing method of a drawn glass member by continuously drawing, under cooling, an end of a glass base material softened by heating, wherein the drawing is performed while keeping constant a drawing length, thereby suppressing a distortion or a buckling in the drawn glass resulting from an unevenness in drawing, and attaining a higher quality.

### BACKGROUND OF THE INVENTION

1. Field of the Invention

The present invention relates to a producing method of a drawn glass member by heated drawing, a producing method of a spacer for an image display apparatus and a producing method of an image display apparatus utilizing such drawn glass member.

2. Related Background Art

It is already known to extract an end portion of a glass base material, softened under heating in a heating furnace, continuously from the heating furnace under drawing and cooling thereby obtaining a drawn glass member of a cross-sectional shape substantially similar to that of the glass base material, and such process is already util-ized for example in producing a base member of an optical fiber or a spacer for a flat panel image display apparatus.

As an example, in the producing method of the spacer for the flat panel image display apparatus, it is already known that an obtained spacer can be improved in similarity to a glass base material by drawing the glass base material under heating so as to obtain a viscosity of 10⁵-10⁹ poise (for example cf. Japanese Patent Application Laid-open No. 2000-203857, paragraphs 0033 and 0034), that an obtained spacer can be improved in compression strength by rapidly cooling the drawn glass member, extracted from the heating furnace, by an external atmosphere (for example cf. Japanese Patent Application Laid-open No. 2003-317648, paragraphs 0039 and 0041), and that an annealing process on a drawn glass member reduces a residual stress thereby preventing a deformation, a bending or a breakage in the use as the spacer (for example cf. Japanese Patent Application Laid-open No. 2003-317653, paragraphs 0038, 0041 and 0043).

However, even when the heat softened glass base material is regulated in viscosity within a predetermined range as described in Japanese Patent Application Laid-open No. 2000-203857, the obtained drawn glass member tends to show a fluctuation in the cross sectional dimension. The drawn glass member is formed by being continuously extracted from an end of the glass base material, but, even when the glass base material is maintained at a constant viscosity, the obtained drawn glass member shows a fluctuation in the cross sectional dimension in time, thereby showing an unevenness in the cross sectional dimension along the longitudinal direction of the glass member.

Methods described in Japanese Patent Application Laid-open-Nos. 2003-317648 and 2003-317653 are not intended to suppress the unevenness in the cross sectional dimension, and are therefore useless for suppressing the unevenness in the cross sectional dimension in the obtained drawn glass member. More specifically, the annealing-treatment described in Japanese Patent Application Laid-open No. 2003-317648 is executed after the drawn glass member is once formed, namely after the drawing force is released and the cross sectional dimension is fixed. Also it only relaxes the residual stress and cannot correct the unevenness in the cross sectional dimension of the drawn glass member. Also according to the experience of the present inventors, the rapid cooling by the external atmosphere, described in Japanese Patent Application Laid-open No. 2003-317653 tends to enhance the unevenness of the cross sectional dimension in the obtained drawn glass member.

### SUMMARY OF THE INVENTION

An object of the present invention is to enable continuous production of a highly precise drawn glass member having an uniform cross sectional dimension in any position of the longitudinal direction. Another object of the present invention is to improve a dimensional precision of a spacer for an image display apparatus, thereby enabling easy production of an image display apparatus of a high quality.

The present invention provides a producing method of a drawn glass member by continuously drawing, under cooling, an end of a glass base material softened by heating, wherein the drawing is executed while keeping constant a drawing length.

The present invention also provides a producing method of a drawn glass member by continuously drawing, under cooling, an end of a glass base material softened by heating, wherein the drawing is completed in a hood provided in continuation from the heating furnace along the drawing direction.

The present invention further provides a producing method of a drawn glass member by continuously drawing, under cooling, an end of a glass base material softened by heating, wherein a coolant gas is blown onto the drawn glass member drawn from the heating furnace, and the drawing is, completed at the blowing position of the coolant gas or immediately after the blowing of the coolant gas.

### BRIEF DESCRIPTION OF THE DRAWINGS

FIG. 1 is a schematic view showing a configuration of an image display apparatus in which a spacer, produced by the producing method of the present invention for the drawn glass member, is applied;

FIG. 2 is a schematic view showing a first embodiment of the producing method of the present invention for a spacer for an image display apparatus;

FIG. 3 is a schematic view showing a second embodiment of the producing method of the present invention for a spacer for an image display apparatus;

FIG. 4 is a schematic view showing a third embodiment of the producing method of the present invention for a spacer for an image display apparatus; and

FIG. 5 is a schematic view showing an example shape of a glass base material and a drawn glass member.

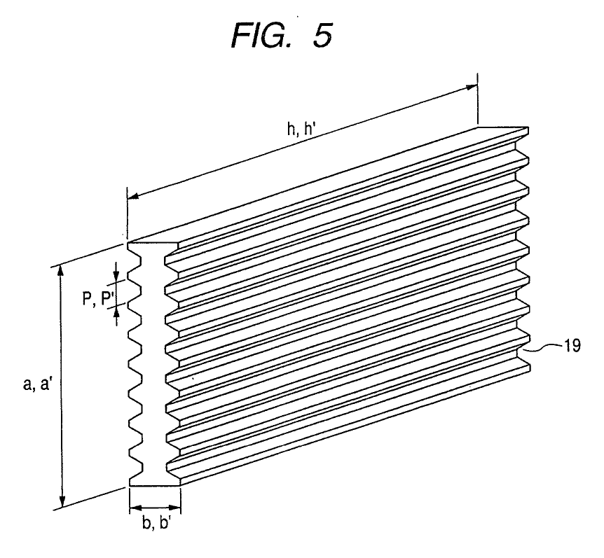

### DETAILED DESCRIPTION OF THE PREFERRED EMBODIMENTS

Exposing a drawn glass member, extracted from a heating furnace, to an external atmosphere is described not only in Japanese Patent Application Laid-open No. 2003-317653 but is considered to be also adopted in Japanese Patent Application Laid-open. No. 2000-203857 or 2003-317648, and can therefore be considered as a very common method is the producing method of the drawn glass member by heat drawing.

However the present inventors have found a following fact and have thus made the present invention. More specifically, an exposure of a drawn glass member, extracted from the heating furnace, immediately to an external atmosphere without any particular control constitutes a cause of unevenness in the cross sectional dimension in the obtained drawn glass member. The external atmosphere without any particular control not only generates a temperature change but also an irregular gas flow, thereby causing a fluctuation in the cooling state of the drawn glass member extracted from the heating furnace. The drawn glass member is still drawn even while being cooled after being extracted from the heating furnace, and such fluctuation in the cooling state causes a variation in a length over which the drawing is executed, thereby causing the aforementioned unevenness.

Thus a first aspect of the present invention is made in consideration of a fact that a fluctuation in the length of drawing is a cause of the unevenness in the cross sectional dimension, and is to provide a producing method of a drawn glass member by continuously drawing an end of a glass base material, softened by heating, under drawing and cooling, wherein the drawing is executed with a constant drawing length.

Also a second aspect of the present invention is made in consideration of a fact that a fluctuation in the cooling state of the drawn glass member extracted from the heating furnace is a cause of the unevenness in the cross sectional dimension, and is to provide a producing method of a drawn glass member by continuously drawing an end of a glass base material, softened by heating, under drawing and cooling, wherein the drawing is completed in a hood provided in continuation to the heating furnace along the drawing direction.

Also a third aspect of the present invention is based on the same fact as in the second aspect, and is to provide a producing method of a drawn glass member by continuously drawing an end of a glass base material, softened by heating, under drawing and cooling, wherein a coolant gas is blown to the drawn glass member extracted from the heating furnace and the drawing is completed at the blowing position of the coolant gas or immediately after the blowing of the coolant gas.

Also fourth and fifth aspects of the present invention provide a producing method of a spacer for an image display apparatus and a producing method of an image display apparatus, utilizing the above-described producing method of the drawn-glass member.

According to the first aspect of the present invention, a drawing length, or a distance from a position where a portion, softened by heating, of the glass base material starts to become thinner in width or in diameter by the extraction of the drawn glass member (reduction starting position) to a position where the extracted drawn glass member becomes no longer drawn by cooling (drawing completion position), is always maintained constant, whereby a drawn glass member of a constant cross sectional dimension can be obtained in continuous manner.

According to the second aspect of the present invention, the drawing and the cooling of the drawn glass member extracted from the heating furnace are executed in a hood, provided in continuation to the heating furnace and serving to intercept the influence of an irregular flow of the external atmosphere or a temperature change thereof, whereby the drawn glass member can be easily maintained always in a constant cooling state. Therefore the drawing length can always be maintained constant, and a drawn glass member of a constant cross sectional dimension can be obtained in continuous manner.

According to the third aspect of the present invention, the drawing length can always be maintained constant by a blowing position of a coolant gas, whereby a drawn glass member of a constant cross sectional dimension can be obtained in continuous manner.

According to the fourth and fifth aspects of the present invention, an image display apparatus of a high quality, utilizing a spacer of a high precision, can be easily obtained.

The producing method of the present invention for the drawn glass member is applicable not only to the manufacture of a spacer for an image display apparatus, but also to the manufacture, for example, of a base member of an optical fiber. As a high dimensional precision is required particularly in the spacer for the image display apparatus, the method of the present invention, capable of attaining a reproducibility in shape of a precision of plus/minus several micrometers, can be advantageously applied to the manufacture of the spacer for the image display apparatus.

In the following, the present invention will be clarified further by a producing method of a spacer of an image display apparatus, as an example.

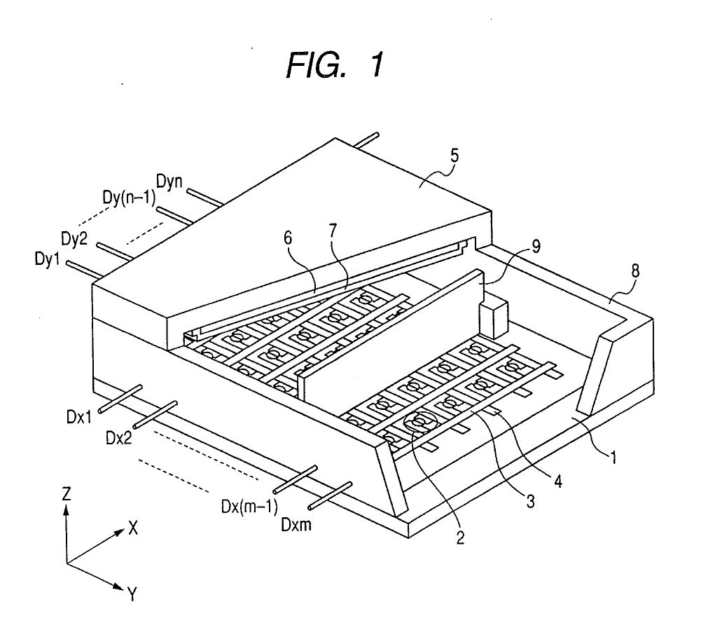

At first, FIG. 1 is a schematic view of an image display apparatus, utilizing a spacer produced by the producing method of the present invention for the drawn glass member.

A rear plate 1 is provided with an electron source, constituted of plural electron emitting devices-2 which are wired in a matrix by plural row wirings 3 and plural column wirings 4.

A face plate 5 is provided with a phosphor 6 and a metal back 7 constituting an anode electrode.

In this image display apparatus the electron source formed on the rear plate 1 emits electrons according to an image signal. The emitted electrons are accelerated by the metal back 7, formed oh the face plate 5 and given a high voltage of 1-20 kV, and irradiate the phosphor 6 thereby displaying an image corresponding to the image signal. As the electron emitting device 2 constituting the electron source, there is employed an already known device such as a field emission device (FE), an MIM electron emitting device or a surface conduction-electron emitting device.

The rear plate 1 and the face plate 5 are seal bonded with a sealant to an outer frame member 8 provided therebetween, and the rear plate 1, the face plate 5 and the frame member 8 constitute a vacuum container.

The interior of such vacuum container is maintained at a vacuum of 10⁻⁴-10⁻⁶ Pa, and plural spacers 9 are provided therein as structural members for internally supporting the vacuum container against the atmospheric pressure applied thereto.

In the following, there will be explained embodiments of the producing method of the spacer for the above-described image display apparatus, with reference to the accompanying drawings.

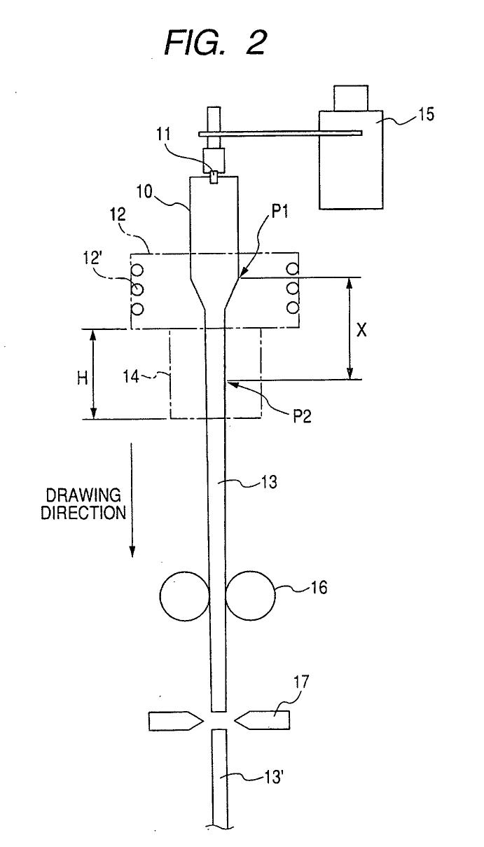

FIG. 2 is a schematic view showing a first embodiment of the producing method of the present invention for the spacer for the image display apparatus.

A glass base material 10 to be drawn into a spacer 9 for the image display apparatus is constituted, for example, by SD18 manufactured by Sumita Kogaku Co.

The glass base material 10, formed in a predetermined shape, is supported at an end thereof by a pinching member 11 of a base material feeding apparatus 15. The pinching member 11 is gradually lowered by the base material feeding apparatus 15 to feed the other end of the glass base material 10 into a heating furnace 12 including a first heater 12′, thereby heating and softening such end of the glass base material 10 to a temperature enabling continuous extraction and drawing. The heating temperature is suitably selected at or higher than a softening temperature.

A feeding rate of the glass base material 10 into the heating furnace 12 by the feeding apparatus 15 is usually selected at about 1-5 mm/min. The interior of the heating furnace 12 is set at such a temperature that, depending upon the type of the glass base material 10, the end of the glass base material 10 fed into the heating furnace 12 assumes a viscosity of 7.0-7.9 poise, and such temperature is preferably controlled with a precision of ±0.1° C. in consideration of stability of drawing operation.

The end-portion of the glass base material 10, heated to the aforementioned temperature in the heating furnace 12′, is suspended by softening and is drawn into a drawn glass member 13, which is extracted, in the course of drawing, from the heating furnace 12 into a tubular hood 14 provided in continuation to the heating furnace 12.

The hood 14 has a heat insulating property and is suitably regulated in a length thereof along the drawing direction of the drawn glass member 13 so as to form, inside the hood 14, a temperature slope showing a gradual temperature decrease along the drawing direction (for example from the softening temperature T1 of the glass base material 10 to a solidifying temperature T2 thereof or a lower temperature). The drawn glass member 13 moves under drawing in the hood 14 and is cooled to the solidifying temperature of the drawn glass member 13 where the drawing operation is completed. Such position where the drawing operation is completed is defined as a drawing completion position P2.

The drawn glass member 13, cooled to the solidifying temperature in the hood 14 and thus having completed the drawing, is taken up by a pair of take-up rollers 16.

A take-up speed by the take-up rollers 16 is preferably 1000-5000 mm/min, and a ratio of the feeding speed and the take-up speed [(take-up speed)/(feed speed)] is preferably within a range of 200-2000 in order to maintain a similarity in the cross sectional shape between the glass base material 10 and the drawn glass member 13 after the drawing.

The drawn glass member 13 after passing the take-up roller 16 is cut by a cutter 17 into a slat or pillar-shaped drawn glass member 13′ of a desired length. The drawn glass member 13′ may be employed immediately as the spacer 9 (cf FIG. 1), but is usually subjected to another process for obtaining the spacer 9. Also the drawn glass member 13 prior to the cutting may be continuously coated, on the surface thereof, with a surface coating material or a surface treating material. Also the drawn glass member 13 may be taken out in a long form as a base member for an optical fiber.

The interior of the hood 14 is a stabilized thermal convection and is not affected by the external air flow, thus showing the aforementioned temperature slope in a stable state, whereby the drawing completion position P2, at which the drawn glass member 13 is cooled to the solidifying temperature and completes the drawing operation, moves scarcely. Consequently the drawn glass member 13 is maintained at a constant drawing length, whereby the drawn glass member 13, 13′ or the spacer 9 (cf. FIG. 1) thus produced shows an excellent shape reproducibility.

The drawing length means a distance X from a position where the glass base material 10 starts to be extracted as the drawn glass member 13 along the drawing direction, namely a reduction start position P1 where the glass base material 10 starts to become smaller in width or in diameter by the extraction as the drawn glass member 13 to a drawing completion position P2 where the extracted drawn glass member 13 is cooled to the solidifying temperature thereby completing the drawing.

In the absence of the hood 14, the drawing completion position P2 fluctuates in the drawing direction, whereby the drawing length X cannot be maintained constant and the drawn glass member 13 to be produced is deteriorated in shape reproducibility. Such fluctuation in the drawing length X is presumably caused by a fact that the drawn glass member 13, softened under heating by the first heater 12′ of the heating furnace 12 and extracted under drawing from the heating furnace 12, is exposed to the random air flow immediately after emerging from the heating furnace 12, thus showing an irregular temperature fluctuation.

In the preparation of the spacer 9 (cf. FIG. 1); the drawn glass member 13 may be further subjected to a cutting operation for a dimensional adjustment or a process of coating a resistance film on the surface of the drawn glass member 13′. Such resistance film is formed for the purpose of preventing an electrostatic charging on the surface of the spacer 9, by the electrons emitted from the electron source in the image display apparatus shown in FIG. 1.

The resistance film on the drawn glass member 13′ can be coated for example by an evaporation, a sputtering, a CVD or a plasma CVD, and has a thickness of 10 nm-1.0 μm, preferably 50-500 nm, and a surface resistivity of 10⁷-10¹⁴ Ω/sq.

The resistance film can be formed for example by a metal oxide, preferably an oxide of chromium, nickel or copper, because such oxide has a relatively low efficiency of secondary electron emission and is not easily charged even when the spacer is hit by the electrons. In addition to metal oxides, carbon is a preferred material with a low secondary electron emitting efficiency. In particular, amorphous carbon has a high resistance and easily allows to regulate the spacer at a desired resistance. In addition, a nitride of an alloy of germanium and a transition metal or a nitride of an alloy of aluminum and a transition metal is usable in practice, as the resistance can be regulated within a wide range from a conductor to an insulator by a control on the composition of the transition metal.

The spacer 9, prepared as described above, is fixed on the face plate 5 bearing the phosphor 6 and the metal back 7, or on the rear plate 1 bearing the electron source 1, as shown in FIG. 1. Then a sealant such as frit glass or indium is provided on the frame member 8, and then the face plate 5, the frame member 8 and the rear plate 1 are seal bonded in a vacuum chamber so as to obtain the aforementioned vacuum level in thus prepared vacuum chamber thereby obtaining an image display panel.

Thus obtained spacer 9, showing satisfactory reproducibility in shape, realizes a precision in height of plus/minus several micrometers between the face plate 5 and the rear plate 1 either within a single spacer or among plural spacers, thereby avoiding a distortion of an image display plane or a buckling or a tumbling of the spacer 9 at or after the seal bonding operation. After the formation of the image display panel, a drive circuit for the image display is mounted to complete the image display apparatus.

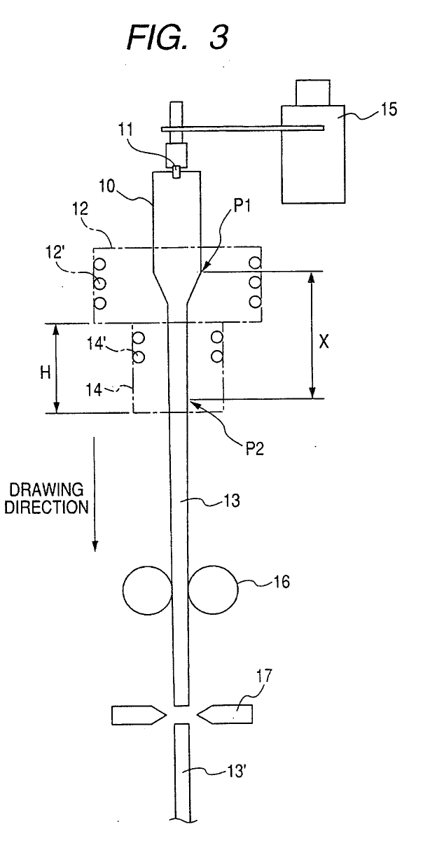

FIG. 3 is a schematic view showing a second embodiment of the producing method of the present invention for the spacer of the image display apparatus, wherein same or equivalent components as in FIG. 2 are represented by same symbols.

The present embodiment is basically similar to the first embodiment shown in FIG. 2, except that a second heater 14′ is provided in the hood 14.

An extracting side of the heating furnace 12 for the drawn glass member 13 is closed except for an aperture for passing the drawn glass member 13, in order to facilitate temperature maintenance in the heating furnace 12. Consequently, a significant temperature difference is often formed between the heating furnace 12 and the interior of the hood 14. The aforementioned second heater 14′ is to reduce such temperature difference and to stabilize the air convection within the hood 14. In an area of the hood 14 at the side of the heating furnace 12, the drawn glass member 13 is heated within a range from the softening temperature to the glass transition temperature, preferably at a temperature lower than the heating temperature by the first heater 12′, for example within a range lower than the softening temperature but equal to or higher than the glass transition temperature. Besides, such heating temperature is preferably controlled with a precision of ±0.1° C. in such a manner that the drawn glass member 13 is cooled within the hood 14 to the solidifying temperature thereby completing the drawing operation (namely that the drawing completion position P2 is located within the hood 14).

Also in case the second heater 14′ is provided inside the hood 14, as in the case where the second 10, heater 14a is absent), there is formed a temperature slope showing a gradual temperature decrease along the drawing direction (for example a temperature slope from the softening temperature T1 of the glass base material 10 to the solidifying temperature T2 thereof or a lower temperature). As the air convection inside the hood 14 is more stabilized than in the case shown in FIG. 2), the fluctuation in the drawing completion position P2 is reduced. Consequently the drawing length X for the drawn glass member 13 is made more constant, and the drawn glass member 13, 13′ or the spacer 9 (cf. FIG. 1) to be produced shows an even better reproducibility in shape.

The cutting of the drawn glass member 13′, the eventual further process for producing the spacer 9 (cf. FIG. 1) and the procedure of producing the image display apparatus are similar to those explained in the first embodiment.

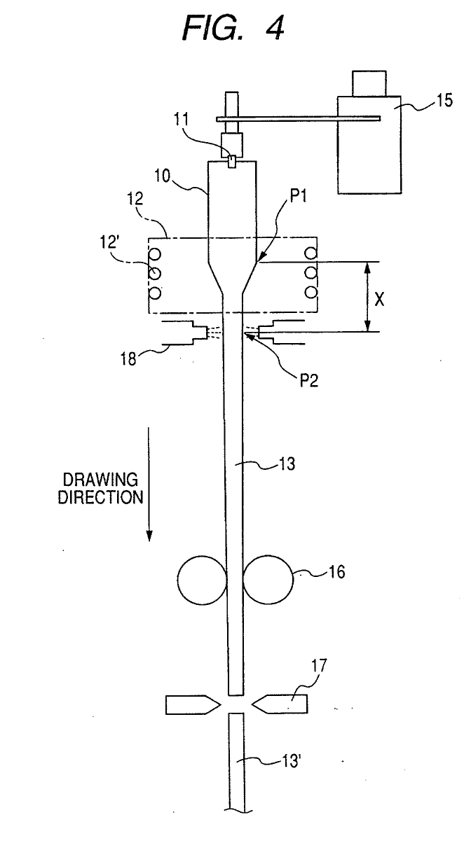

FIG. 4 is a schematic view showing a third embodiment of the producing method of the present invention for the spacer of the image-display apparatus, wherein same or equivalent components as in FIG. 2 are represented by same symbols.

The present embodiment employs, instead of the hood 14 shown in FIG. 2, a nozzle 18 for blowing a coolant gas to the drawn glass member 13 extracted from the heating furnace 12.

The glass base material 10, formed in a predetermined shape, is supported at an end thereof by a pinching member 11 of a base material feeding apparatus 15. The pinching member 11 is gradually lowered by the base material feeding apparatus 15 to feed the other end of the glass base material 10 into a heating furnace 12 including a first heater 12′, thereby heating and softening such end of the glass base material 10 to a temperature enabling continuous extraction and drawing.

The temperature setting in the heating furnace 12 is similar to that in the foregoing first embodiment.

The end portion of the glass base material 10, heated to the aforementioned temperature in the heating furnace 12, is suspended by softening and is drawn into a drawn glass member 13, which is extracted, under drawing, from the heating furnace 12 and is blown by the coolant gas from the nozzle 18 immediately after emerging from the heating furnace 12. The coolant gas has a temperature lower than the softening temperature of the glass base material 10 and forcedly cools the drawn glass member 13 to the solidifying temperature thereof or to a lower temperature, whereby the drawing operation is completed at or immediately after the blowing position of the coolant gas by the nozzle 18. Therefore the drawing-completion position P2 is located at or immediately after the blowing position of the coolant gas by the nozzle 18.

In the present embodiment, the cooling of the drawn glass member 13 to the solidifying temperature can be achieved, by the blowing of the coolant gas, forcedly and instantaneously before it is influenced for example by an external random air flow, whereby the drawing completion position P2 can be prevented from fluctuation.

The coolant gas is preferably an inert gas such as nitrogen gas, and preferably has a temperature of 20-100° C. Also the coolant gas preferably has a flow rate of 0.5-5 L/min, for the purpose of preventing an external perturbation.

The cutting of the drawn glass member 13′, the eventual further process for producing the spacer 9 (cf. FIG. 1) and the procedure of producing the image display apparatus are similar to those explained in the first embodiment.

The drawing length X is maintained constant also in the present embodiment, so that the drawn glass member 13, 13′ or the spacer 9 (cf. FIG. 1) has an excellent shape reproducibility. Also thus obtained spacer 9, showing satisfactory reproducibility in shape, realizes an excellent precision in height between the face plate 5 and the rear plate 1 either within a single spacer or among plural spacers, thereby avoiding a distortion of an image display plane or a buckling or a tumbling of the spacer 9 at or after the seal bonding operation.

### EXAMPLES

### Example 1

In the present example, a spacer for an image display apparatus was prepared by a method shown in FIG. 2.

As the glass base material 10, there was employed glass having a rectangular cross section with a longer side a by a shorter side b of 49.23 mm×6.15 mm, a length h of 600 mm, a softening temperature of 770° C. and a glass transition temperature of 640° C. The glass base material 10 had plural grooves 19 formed with a pitch P=1 mm, on both longer sides a, extending in the direction of length h, in order to form irregularities on both surfaces on the longer sides a.

The glass base material 10 was supported by the pinching member 11 as shown in FIG. 2 in such a manner that the drawing takes place in the direction of length h, and the pinching member 11 was lowered with a range of 5 mm/min so as to feed an end of the glass base material 10 into the heating furnace 12 having the heater 12′ therein. The interior of the heating furnace 12 was controlled at 780° C. (±0.1° C.) where the glass base material 10 assumed a viscosity of logη=7.5 poise.

The end of the glass base material 10 fed into the heating furnace 12 was softened and suspended under drawing, and thus drawn glass member 13 was passed in the hood 14 provided in continuation to the heating furnace 12.

The hood 14 was formed by stainless steel of an excellent heat insulating property, similar to the external wall of the heating furnace 12, and had a length of 120 mm from the lower end of the heating furnace 12.

The paired take-up rollers 16, for taking up the already solidified drawn glass member 13 after passing the hood 14, had a take-up speed of 4733 mm/min, with a ratio (take-up speed)/(feed speed) of about 947.

The drawn glass member 13 was so formed as to have a rectangular cross section of longer side a′×shorter side b′=1.6 mm×0.2 mm, and was cut, after passing the take-up rollers 16, by the cutter 17 to prepare 10 drawn glass members of a slat shape having a length h′=825 mm.

As a result of measurement on the dimensional precision on such 10 drawn glass members 13′, the dimensional fluctuation of the longer side a′ and the shorter side b′ along the direction of length h′ in each drawn glass member 13′ was respectively ±2 μm and ±1 μm. Also an aberration in the pitch of the groove P′ along the direction of length h′ in each drawn glass member 13′ was ±0.1 μm, and an aberration in the pitch between the parallel grooves was ±0.3 μm. Also among the 10 drawn glass members 13′, an aberration in the dimension of the longer side a′ was ±4 μm, an aberration in the dimension of the shorter side b′ was ±2 μm, and an aberration in the pitch of the grooves P′ as ±0.5 μm.

Also after (or in the course of) the drawing work, the base material 10 was taken out and subjected to a measurement of the drawing length X by a three-dimensional measuring device. As a result, the drawing length was found as 150 mm, and the position P2 was at 100 mm from the lower end of the heating furnace 12, confirming that the drawing was completed inside the hood 14.

On thus formed drawn glass member 13′, a resistance film of a nitride compound of tungsten and germanium of a thickness of 200 nm was formed by a reactive sputtering utilizing a W—Ge target in an atmosphere of a mixture of argon and nitrogen. In the present example, the tungsten-germanium nitride film after the film formation had a specific resistivity of 7.9×10³ Ωcm. Also on the faces coming into contact with the row electrode 3 and the metal back 7 shown in FIG. 1, Pt electrodes were formed by a sputtering method to obtain a spacer 9 for the image display apparatus.

The aforementioned spacer 9 was fixed on the row wiring 3 of the rear plate 1 shown in FIG. 1, and then the frame member 8 was fixed to the rear plate 1.

After indium as the sealant was coated on the frame member 8, such rear plate 1 and a face plate 5 bearing a phosphor 6 and a metal back 7 were brought into a vacuum chamber of a vacuum level of 10⁻⁶ Pa, in which the sealant was heated to bond the face plate 1 to the frame member 8, thereby obtaining the image display panel. Then a drive circuit for image display was mounted to complete an image display apparatus.

Thus obtained image display apparatus of the present example was of a high quality, without a distortion of an image display plane or a buckling or a tumbling of the spacer at or after the seal bonding operation.

### Example 2

In the present example, a drawn glass member 13′ for producing a spacer for an image display apparatus was prepared by a method shown in FIG. 3.

A glass base material 16, similar to that employed in Example 1, was supported by the pinching member 11 as shown in FIG. 3, and the pinching member 11 was lowered with a range of 5 mm/min so as to feed an end of the glass base material 10 into the heating furnace 12 having the heater 12′ therein. The interior of the heating furnace 12 was controlled at 780° C. (±0.1° C.) where the glass base material 10 assumed a viscosity of logη=7.5 poise.

The end of the glass base material 10 fed into the heating furnace 12 was softened and suspended under drawing, and thus drawn glass member 13 was passed in the hood 14 provided in continuation to the heating furnace 12.

The hood 14 was similar to that employed in Example 1, and had a length of 120 mm from the lower end of the heating furnace 12. The hood 14 contained a second heater 14′ in a position closer to the heating furnace 12 (within an area of 70 mm from the lower end of the heating furnace 12). In such area of the hood 14 closer to the heating furnace 12, the temperature was controlled at 650° C. (±0.1° C.) where the drawn glass member 13 assumed a viscosity of 13 poise, so as that the drawing of the drawn glass member 13 was completed within a range of 50 mm from the lower end of the hood 14.

The drawn glass member 13, having passed and already having been solidified by passing the hood 14 was taken up by a pair of take-up rollers 16 as in Example 1.

The drawn glass member 13 was so formed as to have a rectangular cross section of longer side a′×shorter side b′=1.6 mm×0.2 mm, and 10 drawn glass members of a slat shape having a length h′=825 mm were prepared.

As a result of measurement on the dimensional precision on such 10 drawn glass members 13′, the dimensional fluctuation of the longer side a′ and the shorter side b′ along the direction of length h′ in each drawn glass member 13′ was respectively ±1.4 μm and ±0.7 μm. Also an aberration in the pitch of the groove P′ along the direction of length h′ in each drawn glass member 13′ was ±0.1 μm, and an aberration in the pitch between the parallel grooves was ±0.2 μm. Also among the 10 drawn glass members 13′, an aberration in the dimension of the longer side a′ was ±2.7 μm, an aberration in the dimension of the shorter side b′ was ±1.4 μm, and an aberration in the pitch of the grooves P′ was ±0.3 μm.

Also in a measurement with by a three-dimensional measuring device as in Example 1, the drawing length X was found as 120 mm, and the position P2 was at 70 mm from the lower end of the heating furnace 12, confirming that the drawing was completed inside the hood 14.

### Example 3

In the present example, a drawn glass member for producing a spacer for an image display apparatus was prepared by a method shown in FIG. 4.

A glass base, material 10, similar to that employed in Example 1, was supported by the pinching member 11 as shown in FIG. 4, and the pinching member 11 was lowered with a range of 5 mm/min so as to feed an end of the glass base material 10 into the heating furnace 12 having the heater 12′ therein. The interior of the heating furnace 12 was controlled at 780° C. (±0.1° C.) where the glass base material 10 assumed a viscosity of logη=7.5 poise.

The end of the glass base material 10 fed into the heating furnace 12 was softened and suspended, under drawing, and thus drawn glass member 13 was passed by a nozzle 18 provided at a position of 5 mm from the lower end of the heating furnace 12, and nitrogen gas of 50° C. was blown from the nozzle 18, with a flow rate of 1 L/min to solidify the drawn glass member thereby completing the drawing.

The drawn glass member 13, having passed the blowing position of nitrogen gas and already solidified was taken up by a pair of take-up rollers 16 as in Example 1.

The drawn glass member 13 was so formed as to have a rectangular cross section of longer side a′×shorter side b′=1.6 mm×0.2 mm, and 10 drawn glass. Members of a slat shape having a length h′ 825 mm were prepared.

As a result of measurement on the dimensional precision on such 10 drawn glass members 13′, the dimensional fluctuation of the longer side a′ and the shorter side b′ along the direction of length h′ in each drawn glass member 13′ was respectively ±2 μm and ±1 μm. Also an aberration in the pitch of the groove P′ along the direction of length h′ in each drawn glass member 13′ was ±0.1 μm, and an aberration in the pitch between the parallel grooves was ±0.2 μm. Also among the 10 drawn glass members 13′, an aberration in the dimension of the longer side a′ was ±4 μm, an aberration in the dimension of the shorter side b′ was ±2 μm, and an aberration in the pitch of the grooves P′ was 0.5 μm.

Also in a measurement with by a three-dimensional measuring device as in Example 1, the drawing length X was found as 180 mm, and it was confirmed that the drawing was completed at about the blowing position of nitrogen gas.

### Comparative Example

10 drawn glass members 13′ were prepared in the same manner as in Example 1, except that the hood 14 was not employed.

As a result of measurement on the dimensional precision on such 10 drawn glass members 13′, the dimensional fluctuation of the longer side a′ and the shorter side be along the direction of length h′ in each drawn glass member 13′ was respectively ±20 μm, and ±10 μm. Also an aberration in the pitch of the groove P′ along the direction of length h′ in each drawn glass member 13′ was ±1 μm, and an aberration in the pitch between the parallel grooves was ±3 μm. Also among the 10 drawn glass members 13′, an aberration in the dimension of the longer side a′ was ±38 μm, an aberration in the dimension of the shorter side b′ was ±20 μm, and an aberration in the pitch of the grooves P′ was ±4 μm.

This application claims priority from Japanese Patent Application No. 2004-343565 filed on Nov. 29, 2004, which is hereby incorporated by reference herein.

What is claimed is:

1. A producing method of a drawn glass member by continuously drawing, under cooling, an end of a glass base material softened by heating, wherein the drawing is executed while keeping constant a drawing length.

2. A producing method of a drawn glass member by continuously drawing, under cooling, an end of a glass base material softened by heating in a heating furnace, wherein the drawing is completed in a hood provided in continuation from the heating furnace along a drawing direction.

3. A producing method of a drawn glass member according to claim 2, wherein a heating is performed so as to suppress a temperature difference between an inside of the heating furnace and an inside of the hood.

4. A producing method of a drawn glass member by continuously drawing, under cooling, an end of a glass base material softened by heating in a heating furnace, wherein a coolant gas is blown onto the drawn glass member drawn from the heating furnace, and the drawing is completed at the blowing position of the coolant gas or immediately after the blowing of the coolant gas.

5. A producing method of a spacer for an image display apparatus utilizing a drawn glass member, wherein the drawn glass member is produced by the producing method of the drawn glass member according to any one of claims 1 to 4.

6. A producing method of an image display apparatus comprising steps of disposing two panels in opposition to each other sandwiching a spacer therebetween, and seal bonding peripheries of the two panels, wherein the spacer is produced by a method according to claim 5.
